(19) United States
(12) Patent Application Publication
(10) Pub. No.: US 2022/0076865 A1
(43) Pub. Date: Mar. 10, 2022

(54) SAMARIUM-IRON-NITROGEN-BASED MAGNETIC MATERIAL

(71) Applicant: Murata Manufacturing Co., Ltd., Nagaokakyo-shi (JP)

(72) Inventor: Satoshi OGA, Nagaokakyo-shi (JP)

(21) Appl. No.: 17/530,735

(22) Filed: Nov. 19, 2021

Related U.S. Application Data
(63) Continuation of application No. PCT/JP2020/019787, filed on May 19, 2020.

(30) Foreign Application Priority Data
May 31, 2019 (JP) 2019-102696

(51) Int. Cl. H01F 1/059; C22C 38/14; C22C 38/10; C22C 38/00

(52) U.S. Cl. CPC H01F 1/059; C22C 38/14; C22C 2202/02; C22C 38/005; C22C 38/001; C22C 38/10

(57) ABSTRACT

A samarium-iron-nitrogen-based magnetic material containing Sm, Fe, N, Ti, and Co at a content of 2.5 at % or less. A content of the Sm may be 7 at % to 10 at %, a content of the Fe may be 65 at % to 80 at %, a content of the N may be 13 at % to 16 at %, and a content of the Ti may be 0.5 at % to 1.5 at %.

### CROSS REFERENCE TO RELATED APPLICATIONS

The present application is a continuation of International application No. PCT/JP2020/019787, filed May 19, 2020, which claims priority to Japanese Patent Application No. 2019-102696, filed May 31, 2019, the entire contents of each of which are incorporated herein by reference.

### FIELD OF THE INVENTION

The present invention relates to a samarium-iron-nitrogen-based magnetic material.

### BACKGROUND OF THE INVENTION

A samarium-iron-nitrogen-based magnetic material containing samarium (Sm), iron (Fe), and nitrogen (N) is known as a rare-earth magnetic material. The samarium-iron-nitrogen-based magnetic material is used as, for example, a raw material for a bonded magnet.

Regarding a samarium-iron-nitrogen-based magnetic material, Patent Document 1 discloses a rare-earth permanent magnet material having a composition component expressed in atomic percent of SmₓRₐFe_{100-x-y-z-a}M_{y}N_{z}, where R represents at least one of Zr and Hf, M represents at least one of Co, Ti, Nb, Cr, V, Mo, Si, Ga, Ni, Mn, and Al, x+a is 7% to 10%, a is 0% to 1.5%, y is 0% to 5%, and z is 10% to 14%. The rare-earth permanent magnet material in Patent Document 1 includes a TbCu₇-type crystal phase or a Th₂Zn₁₇-type crystal phase as a main phase and further includes soft magnetic phase α-Fe. The content of TbCu₇-type crystal phase is 50% or more, the content of Th₂Zn₁₇-type crystal phase is 0% to 50% (except for 0), and the content of soft magnetic phase α-Fe is 0% to 5% (except for 0). According to Patent Document 1, high magnetic characteristics Hcj (coercive force) of 10 kOe (that is, about 796 kA/m) or more is obtained and high thermal stability (irreversible flux loss of a bonded magnet when exposed to air at 120° C. for 2 hours) is obtained (see paragraph [0058] of Patent Document 1).

Patent Document 1: Japanese Unexamined Patent Application Publication No. 2018-157197

### SUMMARY OF THE INVENTION

In general, the heat resistance (heat-resistance temperature) of a magnetic material can be determined through the use of the coercive force as a guideline, and it is believed that higher heat resistance is exhibited when the coercive force becomes higher. The coercive force of the samarium-iron-nitrogen-based magnetic material disclosed in the example described in Patent Document 1 is just 13.0 kOe (that is, about 1,035 kA/m according to Table 3 of Patent Document 1) at maximum. When higher heat resistance is required, it cannot be said that such an extent of coercive force is sufficient.

It is an object of the present invention to realize a new samarium-iron-nitrogen-based magnetic material that exhibits a higher coercive force.

The present inventors originally found that, when a samarium-iron-nitrogen-based magnetic material containing Sm, Fe, and N further contains Ti as an indispensable part thereof, a Co content could be reduced and the coercive force can be improved. As a result of intensive research, the present invention was thus realized.

According to an aspect of the present invention, a samarium-iron-nitrogen-based magnetic material contains Sm, Fe, N, Ti, and Co at a content of 2.5 at % or less, or Co is not included at all.

According to the samarium-iron-nitrogen-based magnetic material of an aspect of the present invention, a new samarium-iron-nitrogen-based magnetic material that exhibits a higher coercive force is realized by containing Ti as an indispensable part and setting the Co content to be 0 at % to 2.5 at %.

### DETAILED DESCRIPTION OF THE INVENTION

A samarium-iron-nitrogen-based magnetic material according to the present embodiment contains samarium (Sm), iron (Fe), nitrogen (N), titanium (Ti) as an indispensable part thereof, and cobalt (Co) at a content of 2.5 at % or less, or no Co at all (hereafter also referred to as “Sm—Fe—Co—Ti—N-based magnetic material”).

Regarding the Sm—Fe—Co—Ti—N-based magnetic material, setting the Co content to 0 at % to 2.5 at % enables a higher coercive force to be obtained, and, as a result, enables the heat resistance (heat-resistance temperature) to be increased. While the coercive force Hcj may be, for example, 1,020 kA/m or more, preferably 1,040 kA/m or more, and more preferably 1,060 kA/m or more, the Sm—Fe—Co—Ti—N-based magnetic material according to the present invention is not limited thereto. It is understood that such a coercive force is sufficiently high relative to the coercive force Hcj of the Sm—Fe—Co—Ti—N-based magnetic material (Sm_{8.5}Zr_{1.2}Fe_{73.4}Co_{4.5}Ti_{1.2}N_{11.2}) of example 8 described in Table 1 of Patent Document 1 being 12.5 kOe (that is, about 995 kA/m). There is no particular limitation regarding the upper limit of the coercive force Hcj of the Sm—Fe—Co—Ti—N-based magnetic material according to the present embodiment, and the coercive force Hcj may be, for example, 3,000 kA/m or less and, typically, 2,500 kA/m or less.

The composition of the Sm—Fe—Co—Ti—N-based magnetic material may be appropriately selected in accordance with the predetermined magnetic characteristics and the like provided that the Co content is within the above-described range. The content (at %) of each element in the Sm—Fe—Co—Ti—N-based magnetic material can be measured by inductively coupled plasma-mass spectrometry (ICP-MS). In addition, the N content can be measured by using an inert gas fusion method.

In the Sm—Fe—Co—Ti—N-based magnetic material according to an aspect of the present invention, the Sm content may be, for example, 7 at % to 10 at %, and may be more specifically 8.0 at % to 9.5 at %. The Fe content may be, for example, 65 at % to 80 at %, and may be more specifically 68 at % to 78 at %. The N content may be, for example, 13 at % to 16 at %, and may be more specifically 14.0 at % to 15.5 at %.

In this regard, the total of the content of each element in the Sm—Fe—Co—Ti—N-based magnetic material is not more than 100 at %. The total of contents of all the elements contained in the Sm—Fe—Co—Ti—N-based magnetic material is theoretically 100 at %.

The content ratio of Sm to Fe in the Sm—Fe—Co—Ti—N-based magnetic material may relate to the crystal structure. The Sm—Fe—Co—Ti—N-based magnetic material may include a crystal phase having a TbCu₇-type structure and/or a Th₂Zn₁₇-type structure, and preferably includes a crystal phase having a TbCu₇-type structure as a main phase (or as a main constituent of the crystal structure). The Sm—Fe—Co—Ti—N-based magnetic material may further include an α-Fe phase. These crystal phases can be examined by powder X-ray diffraction. More specifically, presence and/or an abundance ratio of a crystal phase having a TbCu₇-type structure and a Th₂Zn₁₇-type structure (and α-Fe phase) can be examined by comparing an X-ray diffraction pattern of a Sm—Fe—Co—Ti—N-based magnetic material powder with an X-ray diffraction patterns of SmFe₉ and Sm₂Fe₁₇ (and α-Fe). However, the present embodiment is not limited to these forms.

The Sm—Fe—Co—Ti—N-based magnetic material according to the present embodiment contains Ti as an indispensable part thereof, and, thereby, the coercive force can be improved. The Ti content may be, for example, 0.5 at % to 1.5 at %, and may be more specifically 0.8 at % to 1.4 at %. In the crystal structure of the Sm—Fe—Co—Ti—N-based magnetic material, it is believed that Ti may be present at the location of Fe by substituting therefor, but the present embodiment is not limited to such a form.

The Sm—Fe—Co—Ti—N-based magnetic material according to the present embodiment is not limited to containing Co, as described above, but may contain Co at a content of 2.5 at % or less. The Sm—Fe—Co—Ti—N-based magnetic material containing Co enables the melt viscosity to be reduced when a magnetic material is produced by using a super quenching method described later and thereby enables a quenching loss (a raw material loss generated during production of a thin strip) to be reduced so as to improve a yield (production efficiency). The Co content is thus preferably 0 to 2.5 at % and, may be more specifically 1 at % to 2.5 at %. In the crystal structure of the Sm—Fe—Co—Ti—N-based magnetic material, it is believed that Co may be present at the location of Fe by substituting therefor, but the present embodiment is not limited to such a form.

The Sm—Fe—Co—Ti—N-based magnetic material according to the present embodiment may contain any other appropriate elements.

For example, the Sm—Fe—Co—Ti—N-based magnetic material according to the present embodiment may further contain Zr and, thereby, can increase the maximum energy product. The Zr content may be, for example, 0.5 at % to 1.5 at % and may be more specifically 0.8 at % to 1.4 at %. In the crystal structure of the Sm—Fe—Co—Ti—N-based magnetic material, it is believed that Zr may be present at the location of Sm by substituting therefor, but the present embodiment is not limited to such a form.

Examples of other elements that may be added include at least one selected from the group consisting of V, Cr, Mn, Ga, Nb, Si, Al, and Mo. When such an element is present, the content thereof (in the instance of a plurality of elements, the total of each content) may be, for example, 2.0 at % or less, and may be more specifically 1.8 at % or less.

The Sm—Fe—Co—Ti—N-based magnetic material according to the present embodiment may have any appropriate shape. For example, a powder of a Sm—Fe—Co—Ti—N-based magnetic material may be adopted and may have a particle diameter of about 1 to 300 μm although there is no particular limitation regarding the particle diameter. Alternatively, for example, a form of a bonded magnet obtained by mixing a Sm—Fe—Co—Ti—N-based magnetic material powder and a binder such as a resin or plastic and performing forming into a predetermined shape and solidification may be adopted.

The Sm—Fe—Co—Ti—N-based magnetic material according to the present embodiment can be produced by, for example, a super quenching method. The super quenching method can be performed as described below. Initially, a master alloy is prepared by mixing raw material metals constituting the Sm—Fe—Co—Ti—N-based magnetic material at a predetermined composition ratio. The resulting master alloy is melted (made to take on a molten state) in an argon atmosphere and sprayed on a single rotating roll (for example, a circumferential velocity of 30 to 100 m/s) so as to undergo super quenching. As a result, a thin strip (or a ribbon) composed of an alloy (in an amorphous state) is obtained. The resulting thin strip is pulverized so as to obtain a powder (for example, a maximum particle diameter of 250 μm or less). The resulting powder is subjected to heat treatment in an argon atmosphere at a temperature higher than or equal to a crystallization temperature (for example, at 650° C. to 850° C. for 1 to 120 minutes). Subsequently, the heat-treated powder is subjected to a nitriding treatment. The nitriding treatment may be performed by subjecting the heat-treated powder to heat treatment in a nitrogen atmosphere (for example, at 350° C. to 500° C. for 120 to 960 minutes). However, the nitriding treatment can also be performed under an optional appropriate condition by using, for example, an ammonia gas, a mixed gas of ammonia and hydrogen, a mixed gas of nitrogen and hydrogen, or other nitrogen raw materials. The Sm—Fe—Co—Ti—N-based magnetic material according to the present embodiment is obtained as a powder after the nitriding treatment.

The thus obtained Sm—Fe—Co—Ti—N-based magnetic material may have a fine crystal structure. The average size of crystal grains may be, for example, 10 nm to 1 μm and preferably 10 to 200 nm, but the present embodiment is not limited to such a form.

The samarium-iron-nitrogen-based magnetic material according to an embodiment of the present invention has been described above in detail, but the present invention is not limited to such an embodiment.

### EXAMPLES

Production of Samarium-Iron-Nitrogen-Based Magnetic Material

A master alloy was prepared by mixing raw material metals in the composition described in Table 1 except for N at a ratio corresponding to the composition and performing melting in a high-frequency induction furnace.

The resulting master alloy was melted in an argon atmosphere and sprayed on a Mo roll rotating at a circumferential velocity of 30 to 100 m/s so as to undergo super quenching. As a result, a thin strip was obtained.

The resulting thin strip was pulverized so as to obtain a powder having a maximum particle diameter of 32 μm or less (screening was performed by using a sieve with an opening size of 32 μm).

The resulting powder was subjected to heat treatment in an argon atmosphere at 725° C. to 825° C. for 3 to 30 minutes.

Subsequently, the heat-treated powder was subjected to heat treatment in a nitrogen atmosphere at 460° C. for 8 hours so as to be nitrided.

A sample of the Sm—Fe—Co—Ti—N-based magnetic material according to the present embodiment was obtained as a powder after nitriding.

Composition Analysis and Evaluation of Magnetic Characteristics

The composition of the sample obtained above was analyzed by inductively coupled plasma-mass spectrometry (ICP-MS).

In addition, the magnetic characteristics of the sample obtained above was evaluated. Regarding the evaluation, the true density of the sample (powder) was assumed to be 7.6 g/cm₃, demagnetizing-field correction was not performed, and the coercive force Hcj, the remanent magnetic flux density Br, and the maximum energy product (BH)max were measured by using a vibrating sample magnetometer (VSM).

The results of these are described in Table 1.

In this regard, according to examination of the sample obtained above by powder X-ray diffraction, it was ascertained that all the samples included a crystal phase having a TbCu₇⁻type structure and/or a Th₂Zn₁₇-type structure and further included an α-Fe phase.

TABLE 1

| | | | | | | | Magnetic characteristics | | |
|---|---|---|---|---|---|---|---|---|---|
| | Composition (% by atom) | | | | | | Hcj | Br | (BH)max |
| No. | Sm | Co | Zr | Ti | Fe | N | (kA/m) | (T) | (kJ/m³) |
| 1* | 8.3 | 4.4 | 1.2 | 1.2 | 70.6 | 14.3 | 1010 | 0.72 | 60 |
| 2* | 8.2 | 3.0 | 1.2 | 1.2 | 72.1 | 14.4 | 997 | 0.70 | 57 |
| 3 | 8.3 | 2.1 | 1.2 | 1.2 | 71.9 | 15.3 | 1102 | 0.78 | 82 |
| 4 | 8.2 | 1.0 | 1.2 | 1.2 | 74.1 | 14.4 | 1142 | 0.74 | 65 |
| 5 | 8.0 | | 1.1 | 1.1 | 74.7 | 15.0 | 1280 | 0.74 | 75 |
| 6 | 8.3 | 2.1 | | 1.2 | 74.4 | 14.0 | 1088 | 0.76 | 77 |
| 7 | 8.6 | | | 1.2 | 75.9 | 14.4 | 1250 | 0.71 | 66 |
| 8 | 9.4 | | | 1.2 | 74.9 | 14.6 | 1970 | 0.70 | 70 |

In Table 1, an asterisked sample number indicates a sample which is a comparative example of the present invention, and a blank column of the component indicates zero (no presence/no use of raw material metal). Sample No. 1 and No. 2 are comparative examples of the present invention, and Sample Nos. 3 to 8 are examples of the present invention.

Sample No. 1 Substantially Corresponds to the Sm—Fe—Co—Ti—N-Based Magnetic Material

(Sm_{8.5}Zr_{1.2}Fe_{73.4}Co_{4.5}Ti_{1.2}N_{11.2}) of example 8 described in Table 1 of Patent Document 1. Regarding sample Nos. 2 to 7, the Co content was set to be less than that of No. 1 while the Sm content was set to be within the range of 8.0 at % to 8.6 at %.

According to comparison between sample No. 1 and No. 2, when the Co content was reduced from 4.4 at % to 3.0 at %, the coercive force was substantially not changed, or rather slightly reduced. On the contrary, sample Nos. 3 to 5 in which the Co content was set to be 2.5 at % or less obtained a higher coercive force than sample No. 1. More specifically, As indicated by sample Nos. 3 to 5, a higher coercive force Hcj was obtained with decreasing Co content within the range of 2.5 at % or less. These results indicate that the coercive force rapidly increases by setting the Co content to be less than or equal to a predetermined threshold value.

Regarding sample Nos. 6 and 7, the Co contents were set to be equal to the Co contents of sample Nos. 3 and 5, respectively, and the Zr contents were set to be 0 at %. According to comparison between sample No. 3 and sample No. 6 and comparison between sample No. 5 and sample No. 7, it was ascertained that even when Zr was not present, the coercive force was substantially not changed. Therefore, it is understood that equally high coercive forces are obtained regardless of presence of Zr. From another viewpoint, according to the comparisons above, it was ascertained that a larger maximum energy product was obtained when Zr was present.

Regarding sample No. 8, the level of the Sm content was increased compared with sample Nos. 1 to 7. From the result of sample No. 8, it was found that the coercive force at a higher level was obtained by increasing the level of the Sm content.

The samarium-iron-nitrogen-based magnetic material according to the present invention can be used as a magnet material, for example, a bonded magnet that is formed into an optional appropriate shape and that is used for various applications.

1. A samarium-iron-nitrogen-based magnetic material comprising:
Sm;
Fe;
N;
Ti; and
Co at a content of 2.5 at % or less.

2. The samarium-iron-nitrogen-based magnetic material according to claim 1, wherein the content of the Co is 0 at %.

3. The samarium-iron-nitrogen-based magnetic material according to claim 1,
wherein a content of the Sm is 7 at % to 10 at %,
a content of the Fe is 65 at % to 80 at %,
a content of the N is 13 at % to 16 at %, and
a total of all contents of the samarium-iron-nitrogen-based magnetic material is not more than 100 at %.

4. The samarium-iron-nitrogen-based magnetic material according to claim 3, wherein a content of the Ti is 0.5 at % to 1.5 at %.

5. The samarium-iron-nitrogen-based magnetic material according to claim 1, wherein a content of the Ti is 0.5 at % to 1.5 at %.

6. The samarium-iron-nitrogen-based magnetic material according to claim 1, further comprising Zr.

7. The samarium-iron-nitrogen-based magnetic material according to claim 6, wherein a content of the Zr is 0.5 at % to 1.5 at %.

8. The samarium-iron-nitrogen-based magnetic material according to claim 1, wherein a content of the Sm is 8.0 at % to 9.5 at %.

9. The samarium-iron-nitrogen-based magnetic material according to claim 1, wherein a content of the Co is 1 at % to 2.5 at %.

10. The samarium-iron-nitrogen-based magnetic material according to claim 1, wherein the samarium-iron-nitrogen-based magnetic material includes a crystal phase having a TbCu₇-type structure and/or a Th₂Zn₁₇-type structure.

11. The samarium-iron-nitrogen-based magnetic material according to claim 10, wherein the TbCu₇-type structure is a main constituent of the crystal phase.

12. The samarium-iron-nitrogen-based magnetic material according to claim 3, wherein
the content of the Sm is 8 at % to 9.5 at %,
the content of the Fe is 68 at % to 80 at %, and
the content of the N is 14 at % to 15.5 at %.

13. The samarium-iron-nitrogen-based magnetic material according to claim 4, wherein the content of the Ti is 0.8 at % to 1.4 at %.

14. The samarium-iron-nitrogen-based magnetic material according to claim 6, wherein the content of the Zr is 0.8 at % to 1.4 at %.

15. The samarium-iron-nitrogen-based magnetic material according to claim 1, further comprising at least one element selected from the group consisting of V, Cr, Mn, Ga, Nb, Si, Al, and Mo.

16. The samarium-iron-nitrogen-based magnetic material according to claim 15, in which a total content of the at least one element is 2.0 at % or less.

17. The samarium-iron-nitrogen-based magnetic material according to claim 15, in which a total content of the at least one element is 1.8 at % or less.
